(19) United States
(12) Patent Application Publication
(10) Pub. No.: US 2026/0231244 A1
(43) Pub. Date: Aug. 6, 2026

(54) NPCA MISALIGNMENT AND NAV MANAGEMENT

(71) Applicant: Intel Corporation, Santa Clara, CA (US)

(72) Inventor: Laurent Cariou, Milizac (FR)

(21) Appl. No.: 19/427,889

(22) Filed: Dec. 19, 2025

Related U.S. Application Data
(60) Provisional application No. 63/752,289, filed on Jan. 31, 2025.
(60) Provisional application No. 63/781,112, filed on Mar. 31, 2025.

(51) Int. Cl. H04W 74/0833; H04W 74/0838

(52) U.S. Cl. CPC H04W 74/085; H04W 74/0838

(57) ABSTRACT

A system and method for managing Non-Primary Channel Access (NPCA) misalignment and Network Allocation Vector (NAV) in wireless local area networks (WLANs) are disclosed. A wireless device detects overlapping basic service set (OBSS) activity on a primary channel, switch to a non-primary channel, and maintain a backoff counter without reset. NPCA operations include PPDU-based and TxOP-based mechanisms, where the device receives frames with duration fields, encodes synchronization data, and transmits control frames initiating transmission opportunities with NPCA maximum TxOP duration in designated fields. NAV management is performed by processing preamble information from received physical layer protocol data units (PPDUs) to determine network parameter configurations and adjust device operation.

### PRIORITY CLAIMS

This application claims priority under 35 U.S.C. 119(e) to U.S. Provisional Patent Application Ser. No. 63/752,289, filed Jan. 31, 2025, and U.S. Provisional Patent Application Ser. No. 63/781,112, filed Mar. 31, 2025, each which are incorporated herein by reference in their entireties.

### TECHNICAL FIELD

Embodiments pertain to wireless communications. Some embodiments relate to Non Primary Channel Access (NPCA) misalignment and Network Allocation Vector (NAV) management in wireless local area networks (WLANs).

### BACKGROUND

Wireless devices are becoming widely prevalent and are increasingly requesting access to wireless channels. The Institute of Electrical and Electronics Engineers (IEEE) continues to develop standards for wireless local area networks (WLANs). The complexity of such communication systems, as well as interactions between stations (STAs) within a WLAN system, has increased. In particular, with increasing numbers and variety of devices accessing the network, it is desirable to improve use of channels serving such devices.

### BRIEF DESCRIPTION OF THE DRAWINGS

FIG. 1 is a block diagram of a radio architecture, in accordance with some embodiments.

FIG. 2 illustrates a front-end module circuitry for use in the radio architecture of FIG. 1, in accordance with some embodiments.

FIG. 3 illustrates a radio IC circuitry for use in the radio architecture of FIG. 1, in accordance with some embodiments.

FIG. 4 illustrates a baseband processing circuitry for use in the radio architecture of FIG. 1, in accordance with some embodiments.

FIG. 5 illustrates a WLAN, in accordance with some embodiments.

FIG. 6 illustrates a multi-link framework in accordance with some embodiments.

FIG. 7 illustrates a network environment in accordance with some embodiments.

FIG. 8 illustrates NPCA in accordance with some embodiments.

FIG. 9 illustrates a flow diagram for handling NPCA misalignment in accordance with some embodiments.

FIG. 10 illustrates a flow diagram for NAV system management in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

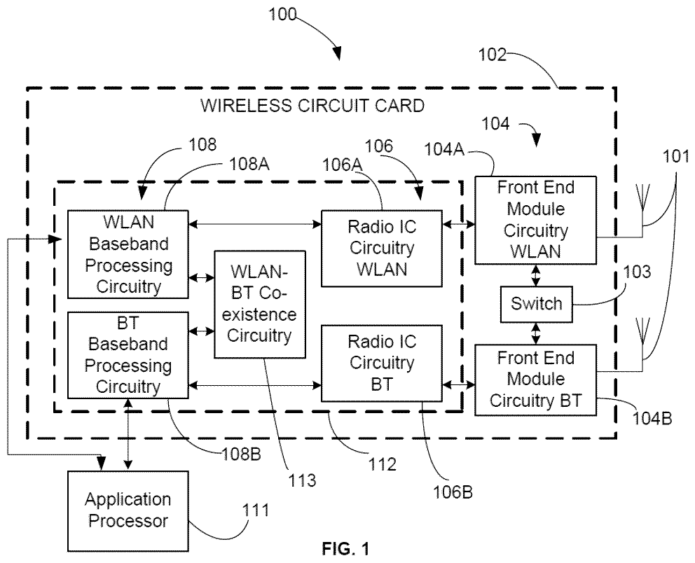

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM CIRCUITRY 104A and FEM CIRCUITRY 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016,, IEEE 802.11ac, IEEE 802.11ax, IEEE P802.11be and/or IEEE P802.11bn standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In some embodiments, the radio architecture 100 may be configured for Extremely High Throughput (EHT) communications in accordance with the IEEE 802.11be standard. In these embodiments, the radio architecture 100 may be configured to communicate in accordance with an OFDMA technique, although the scope of the embodiments is not limited in this respect. In some embodiments, the radio architecture 100 may be configured for next generation vehicle-to-everything (NGV) communications in accordance with the IEEE 802.11bd standard and one or more stations including AP 502 may be next generation vehicle-to-everything (NGV) stations (STAs).

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards.

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80MHz (160 MHz) (with non-contiguous bandwidths). In some embodiments, a 320 MHz channel bandwidth may be used. The scope of the embodiments is not limited with respect to the above center frequencies, however.

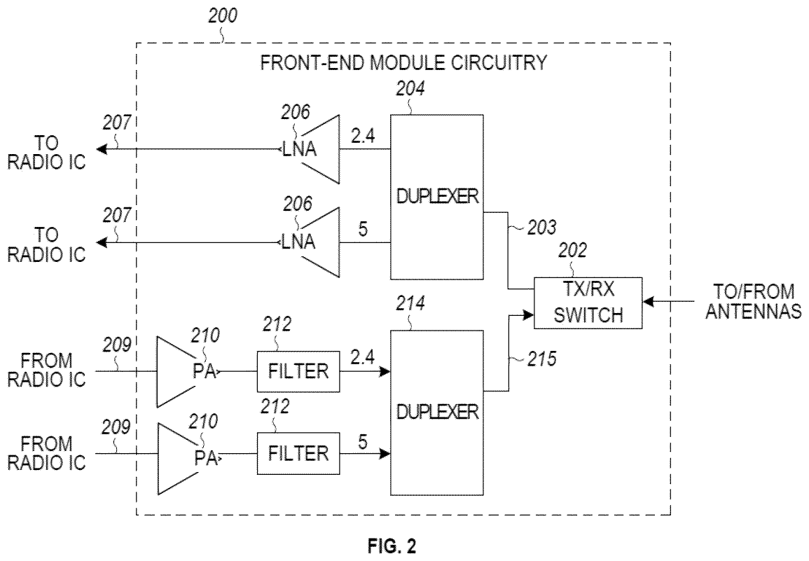

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

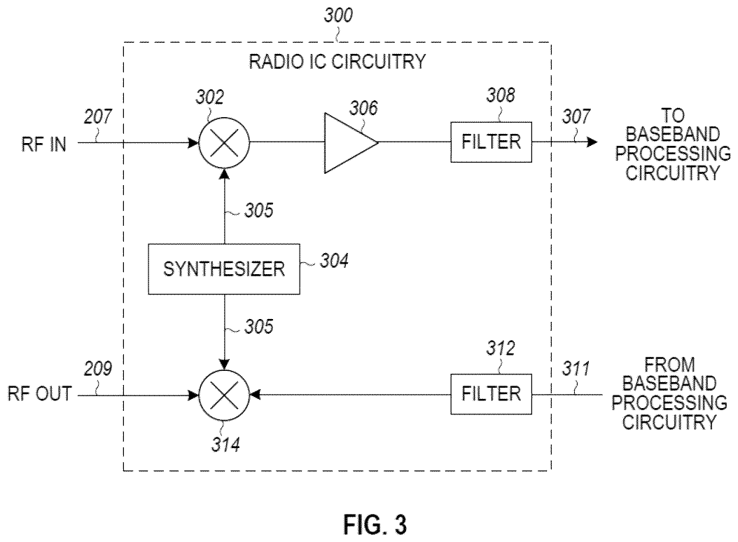

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 304 may be provided by a voltage-controlled oscillator (VCO), although that is not a requirement. A divider control input may further be provided by either the baseband processing circuitry 108 (FIG. 1) or application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

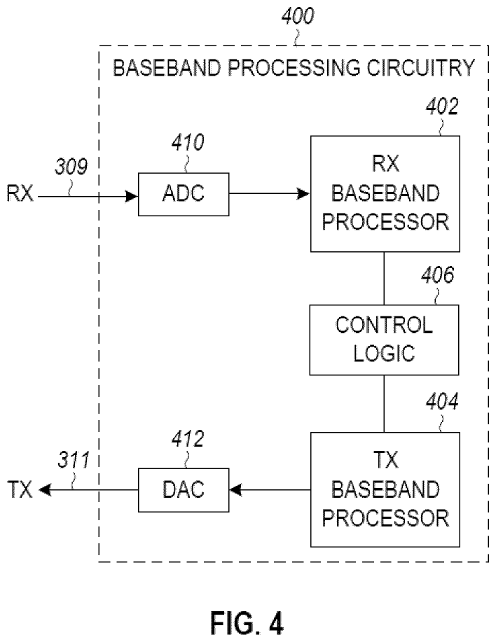

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processing circuitry 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

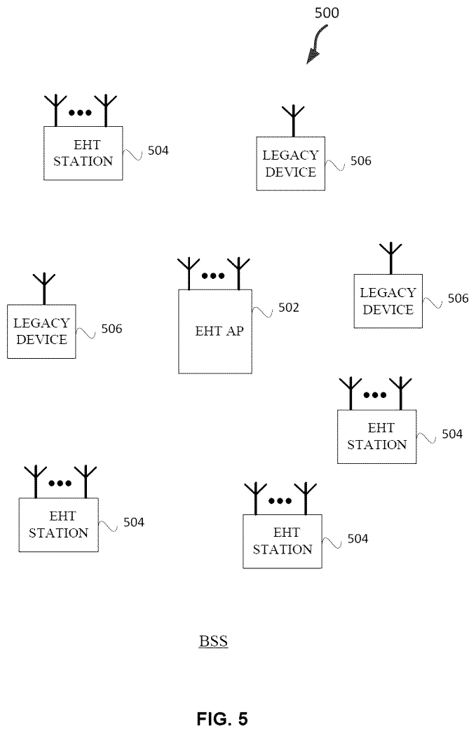

FIG. 5 illustrates a WLAN 500 in accordance with some embodiments. The WLAN 500 may comprise a basis service set (BSS) that may include an access point (AP) 502, which may be an AP, a plurality of stations 504, and a plurality of legacy (e.g., IEEE 802.11n/ac/ax) devices 506. In some embodiments, WLAN 500 may be configured for Extremely High Throughput (EHT) communications in accordance with the IEEE 802.11be standard and one or more stations including AP 502 and stations 504 may be EHT STAs. In some embodiments, WLAN 500 may be configured for Ultra-High Rate (UHR) communications in accordance with one of the IEEE 802.11 standards or draft standards and one or more stations including AP 502 and stations 504 may be UHR and/or UHR+STAs.

In some embodiments, WLAN 500 may be configured for next generation vehicle-to-everything (NGV) communications in accordance with the IEEE 802.11bd standard and one or more stations including AP 502 may be next generation vehicle-to-everything (NGV) stations (STAs).

The AP 502 may be an AP using the IEEE 802.11 to transmit and receive. The AP 502 may be a base station. The AP 502 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502.

The legacy devices 506 may operate in accordance with one or more of IEEE 802.11 wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the STAs 504 may be termed high efficiency (HE) stations.

AP 502 may communicate with legacy devices 506 in accordance with legacy IEEE 802.11 communication techniques. In example embodiments, AP 502 may also be configured to communicate with STAs 504 in accordance with legacy IEEE 802.11 communication techniques.

In some embodiments, a frame may be configurable to have the same bandwidth as a channel. The frame may be a physical Layer Convergence Procedure (PLCP) Protocol Data Unit (PPDU). In some embodiments, there may be several types of PPDUs that may have different fields and different physical layers and/or different MAC layers.

The bandwidth of a channel may be 20 MHz, 40 MHz, or 80 MHz, 160 MHz, 320 MHz contiguous bandwidths or an 80+80MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA PPDU formats. In some embodiments, the 106-subcarrier RU is used in the 20 MHz, 40 MHz, 80 MHz, 160 MHz and 80+80 MHz OFDMA and MU-MIMO PPDU formats. In some embodiments, the 242-subcarrier RU is used in the 40 MHz, 80 MHz, 160 MHz and 80+80 MHz OFDMA and MU-MIMO PPDU formats. In some embodiments, the 484-subcarrier RU is used in the 80 MHz, 160 MHz and 80+80 MHz OFDMA and MU-MIMO PPDU formats. In some embodiments, the 996-subcarrier RU is used in the 160 MHz and 80+80 MHz OFDMA and MU-MIMO PPDU formats.

A frame may be configured for transmitting a number of spatial streams, which may be in accordance with MU-MIMO and may be in accordance with OFDMA. In other embodiments, AP 502, STA 504, and/or legacy device 506 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE and/or EHT communications. In accordance with some IEEE 802.11 embodiments (e.g., IEEE 802.11ax embodiments) a AP 502 may operate as a primary station which may be arranged to contend for a wireless medium (e.g., during a contention period) to receive exclusive control of the medium for a control period. In some embodiments, the control period is a transmission opportunity (TXOP). AP 502 may transmit a master-sync transmission, which may be a trigger frame or control and schedule transmission, at the beginning of the control period. AP 502 may transmit a time duration of TXOP and sub-channel information. During the control period, STAs 504 may communicate with AP 502 in accordance with a non-contention based multiple access technique such as OFDMA or MU-MIMO. This is unlike conventional WLAN communications in which devices communicate in accordance with a contention-based communication technique, rather than a multiple access technique. During the control period, the AP 502 may communicate with STAs 504 using one or more frames. During the control period, the STAs 504 may operate on a sub-channel smaller than the operating range of the AP 502. During the control period, legacy stations refrain from communicating. The legacy stations may need to receive the communication from the AP 502 to defer from communicating.

In accordance with some embodiments, during TXOP the STAs 504 may contend for the wireless medium with the legacy devices 506 being excluded from contending for the wireless medium during the master-sync transmission. In some embodiments the trigger frame may indicate an uplink (UL) UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or non-legacy stations 504 in accordance with legacy IEEE 802.11 communication techniques. In some embodiments, the AP 502 may also be configurable to communicate with STAs 504 outside the TXOP in accordance with legacy IEEE 802.11 communication techniques, although this is not a requirement. Some embodiments are directed to an apparatus of a STA configured for operation in a WLAN comprising processing circuitry and memory. In some embodiments station 504 may be a “group owner” (GO) for peer-to-peer modes of operation. A wireless device may be a station 504 or a AP 502.

In some embodiments, the station 504 and/or AP 502 may be configured to operate in accordance with IEEE 802.11mc. In example embodiments, the radio architecture of FIG. 1 is configured to implement the station 504 and/or the AP 502. In example embodiments, the front-end module circuitry of FIG. 2 is configured to implement the station 504 and/or the AP 502. In example embodiments, the radio IC circuitry of FIG. 3 is configured to implement the station 504 and/or the AP 502. In example embodiments, the base-band processing circuitry of FIG. 4 is configured to implement the station 504 and/or the AP 502.

In example embodiments, the Stations 504, AP 502, an apparatus of the Stations 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein.

In example embodiments, the station 504 and/or the AP 502 are configured to perform the methods and operations/functions described herein. In example embodiments, an apparatus of the station 504 and/or an apparatus of the AP 502 are configured to perform the methods and functions described herein. The term Wi-Fi may refer to one or more of the IEEE 802.11 communication standards. AP and STA may refer to AP 502 and/or STA 504 as well as legacy devices 506.

In some embodiments, the AP and STAs may communicate in accordance with one of the IEEE 802.11 standards. IEEE Std 802.11-2020, IEEE P802.11ax/D8.0, October 2020, IEEE P802.11REVmd/D5.0, IEEE P802.11be/D7.0, August 2024 and IEEE P802.11-REVme/D1.3 are incorporated herein by reference in their entireties.

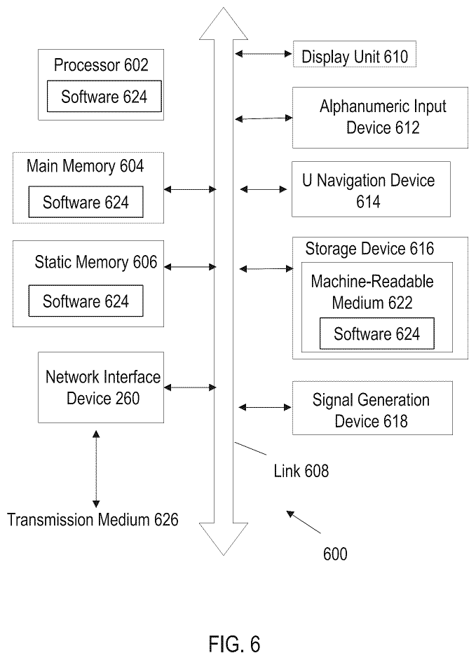

FIG. 6 illustrates a block diagram of a communication device in accordance with some embodiments. The communication device 600 may be a user equipment (UE) or STA such as a specialized computer, a personal or laptop computer (PC), a tablet PC, or a smart phone, dedicated network equipment, a server running software to configure the server to operate as a network device, a virtual device, or any machine capable of executing instructions (sequential or otherwise) that specify actions to be taken by that machine. For example, the communication device 600 may be implemented as one or more of the devices described herein. Note that communications described herein may be encoded before transmission by the transmitting entity for reception by the receiving entity and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 600 may include a hardware processor (or equivalently processing circuitry) 602 (e.g., a central processing unit (CPU), a GPU, a hardware processor core, or any combination thereof), a main memory 604 and a static memory 606, some or all of which may communicate with each other via an interlink (e.g., bus) 608. The main memory 604 may contain any or all of removable storage and non-removable storage, volatile memory or non-volatile memory. The communication device 600 may further include a display unit 610 such as a video display, an alphanumeric input device 612 (e.g., a keyboard), and a user interface (UI) navigation device 614 (e.g., a mouse). In an example, the display unit 610, input device 612 and UI navigation device 614 may be a touch screen display. The communication device 600 may additionally include a storage device (e.g., drive unit) 616, a signal generation device 618 (e.g., a speaker), a network interface device 620, and one or more sensors, such as a global positioning system (GPS) sensor, compass, accelerometer, or another sensor. The communication device 600 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a non-transitory machine readable medium 622 (hereinafter simply referred to as machine readable medium) on which is stored one or more sets of data structures or instructions 624 (e.g., software) embodying or utilized by any one or more of the techniques or functions described herein. The non-transitory machine readable medium 622 is a tangible medium. The instructions 624 may also reside, completely or at least partially, within the main memory 604, within static memory 606, and/or within the hardware processor 602 during execution thereof by the communication device 600. While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the communication device 600 and that cause the communication device 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 624 may further be transmitted or received over a communications network using a transmission medium 626 via the network interface device 620 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 620 may include one or more physical jacks (e.g., Ethernet, coaxial, or phone jacks) or one or more antennas to connect to the transmission medium 626.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single-or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to 3GPP and IEEE-based standards. Aspects described herein may be used in the context of any spectrum management scheme including, for example, dedicated licensed spectrum, unlicensed spectrum, and license exempt spectrum, (licensed) shared spectrum.

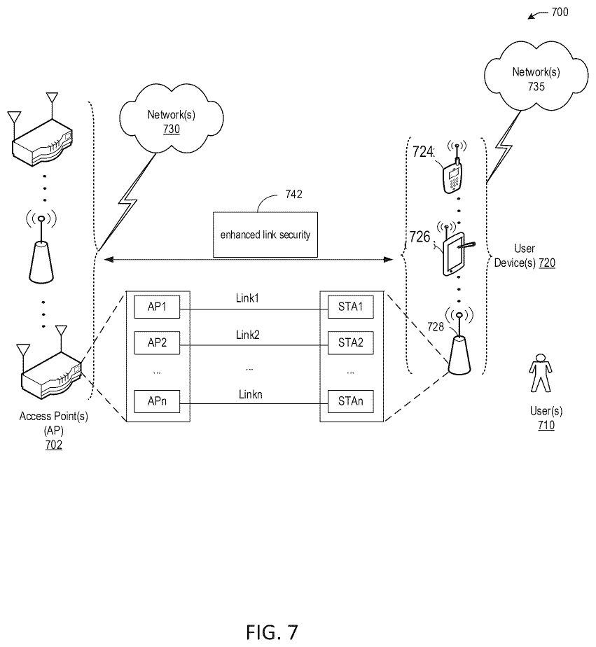

FIG. 7 illustrates network environment in accordance with some embodiments. Wireless network 700 may include one or more user devices 720 and one or more access points(s) (AP) 702, which may communicate in accordance with IEEE 802.11 communication standards. The user device(s) 720 may be mobile devices that are non-stationary (e.g., not having fixed locations) or may be stationary devices.

One or more illustrative user device(s) 720 and/or AP(s) 702 may be operable by one or more user(s) 710. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 720 and the AP(s) 702 may be STAs. The one or more illustrative user device(s) 720 and/or AP(s) 702 may operate as a personal basic service set (PBSS) control point/access point (PCP/AP). The user device(s) 720 (e.g., 724, 726, or 728) and/or AP(s) 702 may include any suitable processor-driven device including, but not limited to, a mobile device or a non-mobile, e.g., a static device. For example, user device(s) 720 and/or AP(s) 702 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 720 and/or AP(s) 702 may also include mesh stations in, for example, a mesh network, in accordance with one or more IEEE 802.11 standards and/or 3GPP standards.

Any of the user device(s) 720 (e.g., user devices 724, 726, 728), and AP(s) 702 may be configured to communicate with each other via one or more communications networks 730 and/or 735 wirelessly or wired. The user device(s) 720 may also communicate peer-to-peer or directly with each other with or without the AP(s) 702. Any of the communications networks 730 and/or 735 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 730 and/or 735 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 730 and/or 735 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 720 (e.g., user devices 724, 726, 728) and AP(s) 702 may include one or more communications antennas. The one or more communications antennas may be any suitable type of antennas corresponding to the communications protocols used by the user device(s) 720 (e.g., user devices 724, 726 and 728), and AP(s) 702. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 720 and/or AP(s) 702.

Any of the user device(s) 720 (e.g., user devices 724, 726, 728), and AP(s) 702 may be configured to perform directional transmission and/or directional reception in conjunction with wirelessly communicating in a wireless network. Any of the user device(s) 720 (e.g., user devices 724, 726, 728), and AP(s) 702 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 720 (e.g., user devices 724, 726, 728), and AP(s) 702 may be configured to perform any given directional transmission towards one or more defined transmit sectors. Any of the user device(s) 720 (e.g., user devices 724, 726, 728), and AP(s) 702 may be configured to perform any given directional reception from one or more defined receive sectors.

MIMO beamforming in a wireless network may be accomplished using RF beamforming and/or digital beamforming. In some embodiments, in performing a given MIMO transmission, user devices 720 and/or AP(s) 702 may be configured to use all or a subset of its one or more communications antennas to perform MIMO beamforming.

Any of the user devices 720 (e.g., user devices 724, 726, 728), and AP(s) 702 may include any suitable radio and/or transceiver for transmitting and/or receiving radio frequency (RF) signals in the bandwidth and/or channels corresponding to the communications protocols utilized by any of the user device(s) 720 and AP(s) 702 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 7, a user device 120 may be in communication with one or more APs 702. For example, one or more APs 702 may implement an enhanced link security 742 with one or more user devices 720. The one or more APs 702 may be multi-link devices (MLDs) and the one or more user device 720 may be non-AP MLDs. Each of the one or more APs 702 may comprise a plurality of individual APs (e.g., AP1, AP2, . . . , APn, where n is an integer) and each of the one or more user devices 720 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

As above, Wi-Fi 8 (e.g., IEEE 802.11bn, 802.11bi) is the next generation of Wi-Fi and a successor to the IEEE 802.11be (Wi-Fi 7) standard. In line with all previous Wi-Fi standards, Wi-Fi 8 aims to improve wireless performance in general along with introducing new features to further advance Wi-Fi technology.

A NAV is a per-STA timer that represents how long a wireless medium is expected to remain busy, as inferred from other frames' duration information. The NAV is a counter maintained by each STA that indicates a period during which the STA defers its own transmissions, even if physical carrier sense reports the channel as idle. The value is derived from the Duration (or Duration/ID) field found in MAC headers of frames such as Request to Send (RTS), Clear to Send (CTS), data, and management frames. When a STA detects a frame, the STA reads the Duration field and sets its NAV to that value if the value is greater than its current NAV. While NAV is non-zero, the STA treats the medium as busy and does not attempt to transmit; the NAV counts down toward zero, at which point the STA may again contend for the medium using Carrier Sense Multiple Access with Collision Avoidance (CSMA/CA) backoff (in which STAs listen before transmitting and use randomized backoff timers to avoid collisions on the shared wireless medium). STAs perform physical carrier sense (CCA) to check if the channel is idle for a distributed coordination function interframe space (DIFS) period, then select a random backoff slot from a contention window (CW) scaled per access category. Transmission occurs after backoff reaches zero; if busy, STAs freeze and resume backoff. This distributed coordination function (DCF) prevents simultaneous transmissions. This helps avoid collisions by informing STAs about ongoing or upcoming frame exchanges that the STAs might not fully hear (e.g., due to the hidden node problem) and reduces the use of continuous physical carrier sensing and supports power saving as STA are able to sleep while NAV is running and wake when the NAV reaches zero to re-check the channel. Note that DIFS is a fixed mandatory wait time before contention-based data transmission, while NAV is a dynamic per-station timer updated by overheard frame durations-STAs wait for NAV=0 (medium free per virtual sense), then sense idle for DIFS before decrementing backoff.

Physical Layer Protocol Data Unit (PPDU)-based NPCA operation is a channel access method in which devices switch transmission to a NPCA primary channel upon detecting an Overlapping Basic Service Set (OBSS) PPDU on the BSS primary channel. In general, when the BSS primary channel is busy due to OBSS PPDUs, a device (APs and STAs) senses the PPDU preamble and switch to the NPCA primary channel, using fields like L-SIG LENGTH or other PPDU signaling to determine the duration of the NPCA stay. The backoff process resumes on the NPCA primary channel without reset, and the device returns to the BSS primary channel once the BSS primary channel becomes idle or the OBSS activity ends (e.g., based on PPDU duration or NAV). The NAV is a virtual carrier-sensing timer maintained by each device that tracks how long the wireless medium will remain busy, preventing transmissions during reserved periods to avoid collisions.

The NPCA primary channel, like the BSS primary channel, is a designated 20 MHz channel used for NPCA contention and transmission when the BSS primary channel is occupied by OBSS traffic. A secondary channel (BSS or NPCA) is a broader secondary spectrum used for actual data transmissions (e.g., 80 MHz). Devices switch from the BSS primary channel to the NPCA primary channel upon OBSS detection, carrying over backoff without reset; once contention succeeds on the NPCA primary channel, the device transmits data PPDUs across the full NPCA secondary channel before returning when the BSS primary idles.

TxOP-based NPCA operation is a variant of NPCA where the duration of channel access on the NPCA primary channel is explicitly signaled and limited by a TxOP field value, typically in 128 μs granularity, rather than being tied solely to detected PPDU durations. In this case, devices detect OBSS activity on the BSS primary channel and switch to the NPCA primary channel, where the devices contend for and obtain a TxOP whose length is indicated in the PPDU or control signaling. The TxOP governs how long each device can transmit before returning or switching back. The backoff counter carries over, and the TxOP limit balances throughput gains against secondary channel contention, with longer TxOPs allowing more A-MPDUs but increasing access delays.

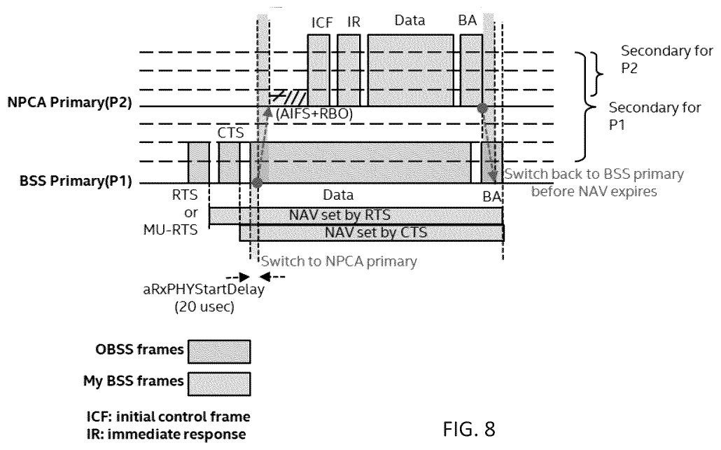

FIG. 8 illustrates NPCA in accordance with some embodiments. FIG. 8 illustrates both issues involved in timing mismatches in use of the NPCA as well as NAV handling.

As illustrated in FIG. 8, the BSS primary channel (P1) is the 20 MHz channel used for contention, carrier sense, and backoff, while the NPCA primary channel (P2) is another 20 MHz channel selected for NPCA operations when OBSS activity makes P1 unavailable. Larger BSS or NPCA secondary channels provide additional bandwidth for the actual payload transmissions when contention succeeds on the corresponding primary channel. NPCA can operate in two modes: PPDU-based NPCA, where the device switches for the duration of a detected OBSS PPDU, and TxOP-based NPCA, where the device switches for the duration of the detected OBSS TxOP. In either case, devices consider conditions before switching, including whether the OBSS occupies the entire bonded bandwidth, and whether the detected OBSS duration is sufficiently long to make the switch worthwhile.

NPCA mismatches arise because NPCA switching is initially “blind” and locally inferred: each device makes its own decision to move from P1 to P2 based on what it hears on the medium. A first mismatch occurs when the AP transitions to the NPCA primary channel (P2) upon detecting OBSS while a given STA does not detect the same OBSS and remains on the BSS primary channel (P1), leaving the AP unable to complete an exchange with that STA on P2. A second mismatch occurs when both peers transition to P2 but in response to different OBSS events or at different times, resulting in different locally computed NPCA durations (PPDU-based peers aligning to different PPDU lengths, TxOP-based peers inferring different TxOP end times) and creating windows of misaligned return or late arrival that risk interference on P2 and the NPCA secondary channel, as illustrated in FIG. 8.

To address the basic alignment problem in which an AP switches but a STA remains on P1, NPCA mandates an initial handshake on the NPCA primary channel before any data exchange. As indicated in FIG. 8, the AP and STA perform an initial control frame (ICF) and initial control response (ICR) exchange on P2 to confirm that both peers have switched and are present. No NPCA data is transmitted until the ICF/ICR handshake completes, confirming co-presence on P2. In a stricter synchronization mode, a non-AP STA that has switched to P2 may wait to transmit until the non-AP STA receives a frame from its AP on P2, thereby ensuring synchronization and preventing late arrivals from initiating unsynchronized transmissions. This handshake prevents wasted transmissions and mitigates interference when transitions are not perfectly synchronized.

The NPCA durations are also explicitly aligned across peers by having each side advertise its computed maximum permissible stay on P2 at the start of the NPCA exchange. In one variation, the AP or STA includes an NPCA Max TxOP Duration in the ICF using a designated Special User Info field identified by a special Association Identifier (AID) value reserved for NPCA parameters. An AID value is assigned by the AP to a STA after the STA successfully associates to the BSS and thus is a per-STA identifier used by the MAC layer to address and manage traffic, signaling, and control information for that STA within the BSS (for example, in TIM/bitmap indexing, per-STA feedback, and special user info fields). The responding peer returns its own NPCA Max TxOP Duration in a Multi-STA Block Acknowledgement (BA) using a Special Per-AID TID Info field, enabling explicit duration reconciliation at handshake time. A priority rule gives precedence to the AP's announced duration when the AP's duration is longer than the STA's; the STA shall adjust its own NPCA duration to match the AP's longer window. Conversely, if the STA's duration is longer than the AP's, the AP shall terminate earlier and return to P1. This AP precedence preserves scheduling integrity across OFDMA/MU-MIMO allocations and prevents fragmentation when some STAs miss the initial OBSS. The NPCA stay concludes by early release using a CF-End frame or upon elapse of the reconciled common NPCA stay window. For operation continuity, a contention backoff counter is carried over from the BSS primary channel to the NPCA primary channel without reset and backoff decrementation resumes upon NPCA entry. NPCA entry conditions include: an intra-BSS reservation being zero on the BSS primary channel, an OBSS occupancy being sufficient in duration to justify switching, and a detected OBSS not covering an entire bonded bandwidth used by the NPCA primary channel and NPCA secondary channels.

In one variation, the ICF includes the NPCA Max TxOP Duration in a designated Special User Info field identified by a special AID value reserved for NPCA parameters, such as AID 2008, and beginning with a Feedback Type set to 1 for NPCA parameters. The responding peer may return its own NPCA Max TxOP Duration in a Multi-STA BA using a Special Per-AID TID Info field, enabling explicit duration reconciliation at handshake time.

An alternative variation avoids introducing new fields by using the legacy Duration field of the ICF to signal the NPCA stay window on P2. The legacy Duration field is a MAC header field present in control and data frames that encodes the remaining time the medium is expected to be reserved for the current or upcoming frame exchange. Receivers use this value to set or update their NAV so they defer transmission until the indicated period elapses. In the NPCA context, the ICF sent on the NPCA primary channel can reuse this existing Duration field to signal the proposed NPCA stay window on P2. The NPCA STA sets the Duration field to the NPCA Max TxOP Duration (optionally reduced by a maximum NPCA switch-back delay agreed between TxOP holder and responder). This approach sets a receiver reservation on the NPCA primary channel based on the legacy Duration field. If the signaled Duration exceeds the responder's permissible NPCA window or the bound tied to the end of ongoing OBSS occupancy on the BSS primary, the responder shall refrain from acknowledging the ICF, and the NPCA session shall not start. If the requester signals a longer window than is ultimately desired, the requester can still release the medium early by sending a CF-End frame that signals the end of a contention-free period or controlled access session, releasing the medium back to normal contention. This approach uses existing header semantics and favors correctness over optimizing cases where peers observed different OBSS events, which are not the main target scenario for NPCA.

A safeguard ties the requested NPCA stay window on P2 to the inferred end of ongoing OBSS occupancy on the BSS primary: the Duration field of an NPCA frame sent on P2 may not exceed the time corresponding to the end of the NAV on the BSS primary minus the maximum NPCA switch-back delay among the TxOP holder and responder(s). If this bound would be exceeded, the responder does not acknowledge the ICF and the NPCA session does not start. This prevents a peer from remaining on P2 past the point it should have returned to P1.

An NPCA AP can announce, along with NPCA parameters for the BSS, a maximum NPCA Transition Delay that is allowed for associated non-AP STAs. Each non-AP STA compares its own transition delay to this BSS-wide limit; a STA with a longer delay does not enable NPCA or has its request to enable NPCA rejected by the AP. This prevents pathological misalignments caused by slow transitions and complements the stricter “wait-for-AP-frame” mode described above.

The AP centrally coordinates medium access for multiple associated STAs in the BSS; giving precedence to the AP's longer announced NPCA Max TxOP Duration unifies the timeline: STAs extend their NPCA stay to match the AP, ensuring that all participants remain aligned on the NPCA channel for a common window. This preserves the AP's scheduling integrity (e.g., across OFDMA/MU-MIMO allocations), reduces collisions from unsynchronized returns, and prevents churn where subsets of STAs oscillate between channels due to inconsistent local inferences of the OBSS end time.

When using the legacy Duration field alternative, mismatch prevention is accomplished by responder behavior: upon parsing an ICF whose Duration exceeds its permissible NPCA period or the bound tied to the end of OBSS occupancy on the BSS primary, the responder refrains from acknowledging the ICF; the absence of an ICR means the NPCA session does not begin. This ensures that peers only engage in NPCA exchanges when the computed windows of the peers are compatible.

In systems supporting both PPDU-based and TxOP-based NPCA, devices may compute NPCA durations differently when observing different OBSS events; explicit duration reconciliation at handshake time and the AP-precedence rule avoid fragmented behavior. FIG. 8 conceptually illustrates these transitions and the potential misalignment windows. The NPCA mismatch resolutions (ICF/ICR handshake, AP-precedence duration reconciliation, special-field signaling (AID/Feedback Type), legacy Duration field alternative with non-ack safeguard, and maximum NPCA Transition Delay) collectively ensure that both sides are present on the NPCA primary channel and aligned to a common NPCA duration window before data exchange begins.

In addition to the NPCA misalignment behaviors described above, NAV management may be an issue. As above, the NAV refers to a per-station virtual carrier-sense timer derived from received frame duration information and indicates a period during which medium access is deferred. The NPCA transitions shown conceptually in FIG. 8 create periods when a BSS primary channel remains reserved by OBSS activity while an NPCA station operates on an NPCA primary channel, and NAV management coordinates those reservations across channels. A receiver reservation on a given primary channel is implemented by setting the corresponding NAV based on received duration information.

NAVs in general may be inter-BSS NAV and intra-BSS NAV. The intra-BSS NAV reflects reservations inferred from frames transmitted within the same BSS to which the STA is associated. Examples include an AP transmitting data to another associated STA, or a control exchange (e.g., RTS/CTS, trigger-based frames) that reserves the medium for intra-BSS traffic. When an intra-BSS NAV is non-zero, the STA defers its own transmissions because the reservation pertains to its own BSS. An inter-BSS NAV reflects reservations inferred from frames transmitted by OBSS, i.e., other BSSs. These frames also carry Duration information that indicates how long the medium is expected to be busy elsewhere. A STA defers while the inter-BSS NAV is non-zero, even if physical carrier sense appears idle, to reduce collisions with the overlapping BSS.

During PPDU-based NPCA operation, an NPCA station transitions to the NPCA primary channel for the duration of a detected OBSS PPDU and then returns to the BSS primary channel at the end of that PPDU. The OBSS TxOP on the BSS primary channel can extend beyond a single PPDU, and therefore the inter-BSS NAV on the BSS primary channel remains non-zero when the NPCA station returns. A receiver on the BSS primary channel continues to defer medium access while the inter-BSS NAV counts down to zero, consistent with the RTS/CTS-derived reservation as indicated by the transitions in FIG. 8. PPDU-based NPCA therefore maintains the inter-BSS NAV on the BSS primary channel while the NPCA station operates on the NPCA primary channel and upon return, preventing premature contention.

During PPDU-based NPCA operation on the NPCA primary channel, a receiver can encounter OBSS activity that affects the NPCA primary channel. To address this condition, NPCA-specific NAV information is maintained on the NPCA primary channel. In one approach, a single NPCA NAV is maintained as a basic reservation timer without differentiating between intra-BSS and inter-BSS sources, thereby reducing implementation complexity. In an alternative approach, two NPCA NAVs are maintained on the NPCA primary channel, an intra-BSS NAV and an inter-BSS NAV, mirroring the BSS primary channel structure. In that alternative, the intra-BSS NAV on the NPCA primary channel is treated consistently with the intra-BSS NAV on the BSS primary channel and remains zero as a precondition before a STA transitions to the NPCA primary channel so that intra-BSS reservations on the BSS primary channel prevent NPCA switching. At the end of the NPCA duration in PPDU-based operation, NPCA NAV information on the NPCA primary channel is reset, and NPCA NAV maintenance restarts on a subsequent NPCA event.

During TxOP-based NPCA operation, an NPCA station transitions to the NPCA primary channel for a duration aligned to the OBSS TxOP inferred on the BSS primary channel and returns at the end of that TxOP. Because the return to the BSS primary channel coincides with the conclusion of the OBSS TxOP, the inter-BSS NAV on the BSS primary channel is zero when the NPCA station resumes contention on that primary channel. The intra-BSS NAV on the BSS primary channel remains zero during NPCA operation because NPCA switching is conditioned on the absence of intra-BSS reservations on the BSS primary channel. TxOP-based NPCA therefore does not maintain an inter-BSS NAV on the BSS primary channel during NPCA operation, as return occurs at the end of the reservation window.

During TxOP-based NPCA operation, NAV information on the NPCA primary channel continues to provide virtual carrier-sense protection. In one approach, two NPCA NAVs are maintained on the NPCA primary channel, an intra-BSS NAV and an inter-BSS NAV, enabling straightforward reuse of existing NAV logic by applying the same structures to the NPCA primary channel while treating the inter-BSS NAV on the NPCA primary channel as zero when the transition occurs. In a simplified approach applicable when both PPDU-based and TxOP-based NPCA are supported, a single NPCA NAV is maintained on the NPCA primary channel as a basic reservation timer without distinguishing intra-BSS and inter-BSS sources. At the end of the NPCA duration in TxOP-based operation, NPCA NAV information on the NPCA primary channel is reset, and NPCA NAV maintenance restarts on a subsequent NPCA event.

The intra-BSS NAV identifies reservations derived from transmissions within the associated BSS, for example an access point communicating with another station in the same BSS, and the inter-BSS NAV identifies reservations derived from transmissions from other BSSs. NPCA switching does not occur when an intra-BSS NAV is non-zero on the BSS primary channel, and therefore NPCA operation assumes that an intra-BSS reservation on the BSS primary channel is zero before a transition begins. The inter-BSS NAV on the BSS primary channel continues to run during PPDU-based NPCA operation and returns to zero at the end of the OBSS TxOP in TxOP-based NPCA operation.

The NPCA ICF and ICR exchange described above are compatible with NAV management on both the BSS primary channel and the NPCA primary channel. The legacy Duration field alternative for signaling an NPCA stay window on the NPCA primary channel sets a receiver's NAV based on the proposed duration and supports early release of the reserved window via a CF-End frame when an NPCA transmission concludes earlier than signaled. The CF-End frame is transmitted by the NPCA station and clearing of NPCA NAV precedes return to the BSS primary channel. A responder that determines a proposed NPCA stay window on the NPCA primary channel would exceed a permissible bound tied to the inferred end of OBSS occupancy on the BSS primary channel refrains from acknowledging the NPCA initial control frame, thereby avoiding engagement in an NPCA session that would outlast the BSS primary channel reservation and maintaining coherent NAV behavior across channels.

The NAV management approaches described above complement NPCA mismatch resolution by providing explicit reservation timers on both the BSS primary channel and the NPCA primary channel. PPDU-based NPCA leverages continued inter-BSS NAV protection on the BSS primary channel during NPCA operation and NPCA NAV protection on the NPCA primary channel, while TxOP-based NPCA leverages NPCA NAV protection on the NPCA primary channel and resumes contention on the BSS primary channel when the OBSS TxOP concludes. The reset behavior for NPCA NAV information upon return to the BSS primary channel simplifies implementation and avoids stale reservations, and the optional single-NAV approach on the NPCA primary channel provides a consistent model across PPDU-based and TxOP-based NPCA. NAV timers on the BSS primary channel and the NPCA primary channel are synchronized by updating or clearing timers responsive to observed signaling and transitions, maintaining coherent deferral periods before resuming monitoring and potential NPCA entry.

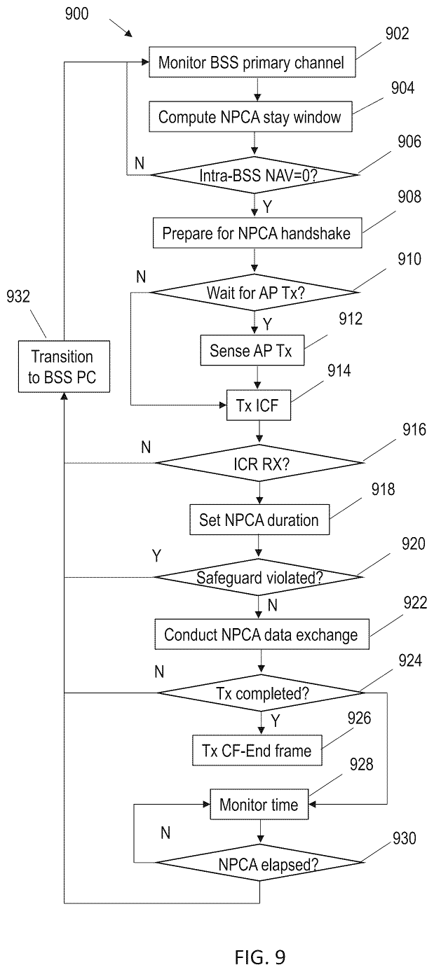

FIG. 9 illustrates a flow diagram for handling NPCA misalignment in accordance with some embodiments. Only some of the operations performed by the STA using the method 900 are shown in FIG. 9; the STA may perform additional operations.

At operation 902, the STA monitors the BSS primary channel for OBSS activity by decoding preambles and headers of received frames to extract Duration information and by evaluating whether detected traffic satisfies NPCA entry conditions, including minimum expected occupancy and non-coverage of the intended NPCA primary channel.

At operation 904, after detection of OBSS activity on the BSS primary channel and that NPCA entry conditions are met, the STA evaluates the NPCA mode selection criteria and locally computes an NPCA stay window on the NPCA primary channel based on the observed event. For PPDU-based NPCA, the window equals the detected OBSS PPDU duration; for TxOP-based NPCA, the window equals the inferred OBSS TxOP duration on the BSS primary channel.

At operation 906, the STA determines whether an intra-BSS NAV on the BSS primary channel is non-zero. If the intra-BSS NAV is non-zero, the STA refrains from NPCA switching and returns to operation 902.

If the intra-BSS NAV is zero at operation 906, at operation 908, the STA transitions to the NPCA primary channel and prepares an ICF for the NPCA handshake, encoding a proposed NPCA Max TxOP Duration either in a Special User Info field (e.g., identified by a special AID value and Feedback Type) or in the legacy Duration field.

At operation 910, a decision is made whether a stricter synchronization mode is configured in which the STA waits for an AP transmission on the NPCA primary channel before transmitting. If stricter synchronization is enabled, the STA waits at operation 912 to receive an AP frame on the NPCA primary channel before transmitting the ICF and continues at operation 914. If stricter synchronization is not enabled, the STA proceeds directly to operation 914.

At operation 914, the STA transmits the ICF on the NPCA primary channel and starts a response timer awaiting an ICR or a Multi-STA BA carrying the peer's NPCA Max TxOP Duration.

At operation 916, the STA determines whether an ICR or Multi-STA BA response is received within the response timer. If no response is received, the STA treats the attempt as unsuccessful, optionally performs a backoff on the NPCA primary channel if permitted, and returns to operation 902 after transitioning back to the BSS primary channel at operation 932. If a response is received, processing proceeds to operation 918.

At operation 918, the STA reconciles the NPCA stay window by comparing the locally computed NPCA duration with the peer-announced NPCA Max TxOP Duration. If the AP's announced duration is longer, the STA adopts the AP's longer window; if the AP's announced duration is shorter, the STA truncates the window to the AP's shorter duration. This establishes a common NPCA window.

At operation 920, the STA determines whether a safeguard bound is violated, namely whether the proposed NPCA window would extend beyond the inferred end of ongoing OBSS occupancy on the BSS primary channel minus a maximum NPCA switch-back delay. If the bound would be violated, the STA aborts the NPCA exchange, refrains from further transmission on the NPCA primary channel, transitions back to the BSS primary channel, and returns to operation 902. If the bound is satisfied, processing proceeds to operation 922.

At operation 922, the STA conducts NPCA data exchanges during the aligned NPCA window on the NPCA primary channel and associated NPCA secondary channel bandwidth, with scheduling controlled by the AP's coordination (e.g., OFDMA or MU-MIMO allocations) and subject to carrier-sense and backoff observed on the NPCA primary channel.

At operation 924, the STA determines whether the intended transmissions have been completed before the signaled end of the NPCA window. If completed early, processing proceeds to operation 926. If not completed, processing proceeds to operation 928.

At operation 926, the STA transmits a CF-End frame on the NPCA primary channel to release the reserved window early and then transitions back to the BSS primary channel to resume standard contention behavior. Processing returns to operation 902.

At operation 928, the STA monitors time against the reconciled NPCA window and continues NPCA transmissions as scheduled until the window elapses or another terminating condition occurs, such as receipt of a CF-End from the AP, a contention failure, or a detected interference event that suspends transmissions.

At operation 930, the STA determines whether the reconciled NPCA window has elapsed. If not elapsed, processing returns to operation 928 to continue within the remaining window. If elapsed, processing proceeds to operation 932.

At operation 932, the STA transitions from the NPCA primary channel back to the BSS primary channel. For PPDU-based NPCA, the STA resumes deferral on the BSS primary channel while any inter-BSS NAV remains non-zero; for TxOP-based NPCA, the STA resumes contention as the inter-BSS NAV is expected to be zero at the end of the OBSS TxOP.

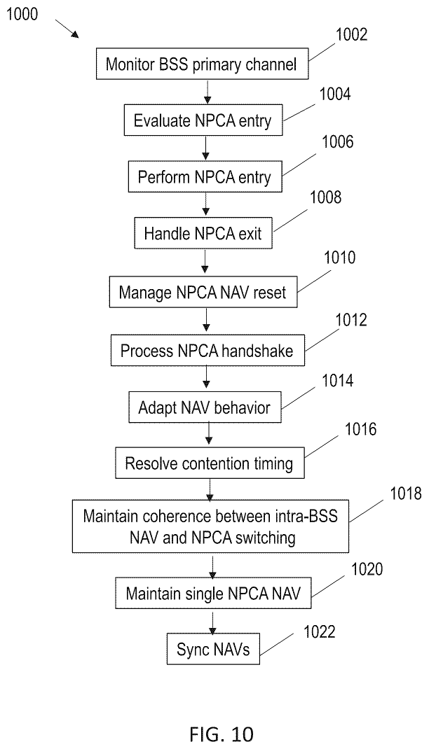

FIG. 10 illustrates a flow diagram for NAV system management in accordance with some embodiments. Only some of the operations performed by the STA using the method 1000 are shown in FIG. 10; the STA may perform additional operations.

At operation 1002, the STA monitors the BSS primary channel and decodes received preambles and headers to extract Duration information, initializing or updating NAV timers that represent intra-BSS NAV (for reservations within the associated BSS) and inter-BSS NAV (for reservations inferred from overlapping basic service sets). The STA determines whether any extracted Duration values indicate a non-zero intra-BSS NAV or inter-BSS NAV on the BSS primary channel.

At operation 1004, the STA evaluates NPCA entry for PPDU-based operation or TxOP-based operation.

For PPDU-based operation, the STA parses an OBSS PPDU on the BSS primary channel and computing a prospective NPCA stay window equal to the detected OBSS PPDU duration. The STA determines whether NPCA conditions are satisfied, including intra-BSS NAV being zero on the BSS primary channel and the OBSS PPDU duration exceeding a minimum threshold.

For TxOP-based operation, the STA infers an OBSS TxOP on the BSS primary channel and computing a prospective NPCA stay window equal to the detected OBSS TxOP duration. The STA determines whether NPCA conditions are satisfied, including intra-BSS NAV being zero on the BSS primary channel and the OBSS TxOP duration exceeding a minimum threshold.

At operation 1006, the STA performs NPCA entry by transitioning to the NPCA primary channel for the computed PPDU/TxOP duration and initializing NPCA NAV protection on the NPCA primary channel. For PPDU-based operation, STA determines whether NPCA NAV will be maintained as a single reservation timer (no differentiation between intra-BSS and inter-BSS sources) or as two NPCA NAVs (intra-BSS and inter-BSS NAVs mirroring the BSS primary channel structure with intra-BSS NAV treated consistently across channels). For TxOP-based operation, the STA determines whether NPCA NAV will be maintained as two NAVs (intra-BSS and inter-BSS NAVs) with inter-BSS NPCA NAV set to zero at transition, or as a single NPCA NAV (no differentiation) applicable when both PPDU-based and TxOP-based modes are supported.

At operation 1008, the STA handles NPCA exit for PPDU/TxOP operation. For PPDU-based operation, the STA returns to the BSS primary channel at the end of the OBSS PPDU while inter-BSS NAV on the BSS primary channel may still be non-zero from an OBSS TxOP that extends beyond a single PPDU. The STA determines whether inter-BSS NAV remains non-zero upon return and, if non-zero, continues to defer contention on the BSS primary channel until inter-BSS NAV counts down to zero. For TxOP-based operation, the STA returns to the BSS primary channel at the end of the OBSS TxOP aligned NPCA duration. The STA determines whether inter-BSS NAV on the BSS primary channel is zero upon return and, if zero, resumes contention; if not zero due to misinference or late observation, defers until NAV reaches zero.

At operation 1010, the STA manages NPCA NAV reset behavior to avoid stale reservations. At NPCA exit for either PPDU-based or TxOP-based operation, NPCA NAV information on the NPCA primary channel is cleared. The STA determines whether a subsequent NPCA event requires re-initialization of NPCA NAV structures before re-entry.

At operation 1012, the STA processes NPCA handshake signaling on the NPCA primary channel that uses a legacy Duration field in an initial control frame to convey a proposed NPCA stay window and sets local NPCA NAV accordingly. The STA determines whether the proposed NPCA window would exceed a permissible bound tied to the inferred end of OBSS occupancy on the BSS primary channel, accounting for maximum NPCA switch-back delay; if the bound would be exceeded, refrains from acknowledging the initial control frame, preventing NPCA engagement that would outlast BSS primary channel reservation.

At operation 1014, the STA adapts NAV behavior to early release signaling. If NPCA transmissions conclude before the signaled window ends, a CF-End frame on the NPCA primary channel indicates termination of the reserved period; local NPCA NAV is cleared, and the STA transitions back to the BSS primary channel. The STA determines whether CF-End has been received or transmitted and, if so, resets NPCA NAV and resumes appropriate contention or deferral per BSS primary channel NAV.

At operation 1016, the STA resolves contention timing on return paths. For PPDU-based NPCA, inter-BSS NAV protection on the BSS primary channel may persist; for TxOP-based NPCA, contention typically resumes immediately. The STA determines whether PPDU-based or TxOP-based NPCA applies on the current cycle and enforces the corresponding NAV handling, ensuring consistent medium access behavior upon return.

At operation 1018, the STA maintains coherence between intra-BSS NAV and NPCA switching by preventing NPCA entry when intra-BSS NAV on the BSS primary channel is non-zero. The STA determines whether intra-BSS NAV equals zero prior to any NPCA transition and, if non-zero, continues deferral on the BSS primary channel without initiating NPCA.

At operation 1020, the STA implements optional simplification by maintaining a single NPCA NAV timer for both intra- and inter-BSS reservations on the NPCA primary channel when both PPDU-based and TxOP-based NPCA are supported. The STA determines whether single-NAV operation is configured and, if configured, applies one NPCA NAV timer; if not configured, applies separate intra-BSS and inter-BSS NPCA NAV timers.

At operation 1022, the STA completes the NAV handling cycle by synchronizing NAV timers across channels and modes. The STA determines whether NAV timers on the BSS primary channel and the NPCA primary channel are consistent with observed signaling and transitions and, if inconsistencies are detected, updates or clears timers to maintain coherent deferral periods before resuming monitoring and potential NPCA entry.

Thus, the embodiments above address misalignment issues that arise during NPCA when an AP and STAs independently decide to switch from a BSS primary channel to an NPCA primary channel upon detecting OBSS activity. Because NPCA switching is locally inferred from medium observations, devices may transition at different times or in response to different OBSS events. Two principal mismatch scenarios are identified: first, the AP may switch to the NPCA primary channel while a given STA remains on the BSS primary channel, making communication impossible; second, both peers may switch to the NPCA primary channel but compute different NPCA stay windows (e.g., different PPDU lengths for PPDU-based NPCA or different TxOP end times for TxOP-based NPCA), causing misaligned return times, late arrivals, and potential interference on the NPCA primary and secondary channels.

To resolve these misalignments, an initial handshake is used on the NPCA primary channel before any data exchange. The initiating device transmits an ICF and expects an ICR to confirm co-presence on the NPCA primary channel; if absent, the NPCA exchange does not start. In a stricter synchronization mode, a non-AP STA that has switched to the NPCA primary channel defers transmission until it receives a frame from the AP on the NPCA primary channel, thereby preventing late arrivals from initiating unsynchronized transmissions. Beyond co-presence, an explicit duration alignment is used in which each peer advertises its computed NPCA Max TxOP Duration during the handshake, and the two peers reconcile a common NPCA stay window. In one variation, NPCA parameters are signaled using a Special User Info field in the ICF identified by a special AID and a Feedback Type designating NPCA parameters, and the responder returns its own NPCA Max TxOP Duration in a Multi-STA BA using a Special Per-AID TID Info field. An AP precedence rule governs reconciliation: when the AP's announced window is longer, the station extends its stay to match; when the AP's window is shorter, the AP terminates earlier and returns to the BSS primary channel, preserving AP-coordinated scheduling and avoiding fragmentation among STAs.

An alternative signaling approach reuses the legacy Duration field of the ICF on the NPCA primary channel to indicate the proposed NPCA stay window. The responder compares the signaled window against its permissible NPCA period; if the window is incompatible or exceeds a bound tied to the inferred end of OBSS occupancy on the BSS primary channel minus a maximum NPCA switch-back delay, the responder simply does not acknowledge the ICF, preventing a mismatched NPCA session. Early termination of a reserved window is enabled via a CF-End frame transmitted on the NPCA primary channel. To avoid pathological misalignments from slow transitions, the AP may announce a maximum NPCA Transition Delay applicable to associated STAs; a station with a longer delay either does not enable NPCA or has its enablement request rejected. Collectively, the handshake, AP-precedence reconciliation, parameter signaling via special fields or legacy Duration, non-ack safeguards, CF-End early release, and maximum transition delay work together to ensure both parties are present and aligned to a common NPCA stay window before data exchange begins.

In addition, NAV management in the presence of NPCA transitions between the BSS primary channel and an NPCA primary channel are described. The embodiments distinguish intra-BSS NAV (reservations originating within the associated BSS, such as AP-to-STA transmissions or RTS/CTS exchanges) from inter-BSS NAV (reservations originating from overlapping BSSs). NAV handling is aligned with two NPCA modes: PPDU-based and TxOP-based NPCA, which dictate how long the device stays on the NPCA primary channel and when it returns to the BSS primary channel.

For PPDU-based NPCA, a station transitions to the NPCA primary channel for the duration of a detected OBSS PPDU and returns to the BSS primary channel at the end of that PPDU. Because an OBSS TxOP may extend beyond a single PPDU, inter-BSS NAV on the BSS primary channel can remain non-zero upon return, and the station continues to defer until inter-BSS NAV counts down to zero. On the NPCA primary channel, NPCA-specific NAV maintenance is introduced. A simplified approach maintains a single NPCA NAV timer without distinguishing source type; an alternative mirrors the BSS primary channel structure by maintaining intra-BSS NPCA NAV and inter-BSS NPCA NAV, with intra-BSS NPCA NAV treated consistently across channels (and assumed zero before switching). NPCA NAV is cleared upon return to the BSS primary channel to avoid stale reservations.

For TxOP-based NPCA, a station transitions to the NPCA primary channel for a duration aligned to the inferred OBSS TxOP and then returns at the end of that TxOP. Because return coincides with the end of the reservation window, inter-BSS NAV on the BSS primary channel is zero upon return, allowing contention to resume. On the NPCA primary channel, NPCA NAV continues to protect medium access; two NPCA NAV timers may be maintained (intra-BSS and inter-BSS NPCA NAV with inter-BSS NPCA NAV set to zero at transition), or a single NPCA NAV may be maintained for systems supporting both PPDU-based and TxOP-based NPCA. NAV behavior is also integrated with NPCA handshake signaling: when using the legacy Duration field of the initial control frame to signal a proposed NPCA stay window on the NPCA primary channel, receivers set NPCA NAV accordingly; if transmissions conclude earlier than signaled, a CF-End frame terminates the reserved window and NPCA NAV is cleared before return. A responder that determines the proposed NPCA stay window would exceed a permissible bound tied to the inferred end of OBSS occupancy on the BSS primary channel refrains from acknowledging the initial control frame, avoiding engagement in an NPCA session that would outlast the BSS reservation.

NPCA mismatch resolution is complemented by providing explicit NAV timers on both primary channels and clear reset and synchronization behaviors. PPDU-based NPCA leverages inter-BSS NAV persistence on the BSS primary channel and NPCA NAV protection on the NPCA primary channel, while TxOP-based NPCA leverages NPCA NAV protection on the NPCA primary channel and returns when inter-BSS NAV is zero on the BSS primary channel. Resetting NPCA NAV upon return simplifies implementation and avoids stale reservations, and optional single-NAV operation on the NPCA primary channel provides a consistent model across NPCA modes. Synchronization of NAV timers across channels via updates or clearing responsive to signaling and transitions maintains coherent deferral periods before monitoring for subsequent NPCA entry.

### EXAMPLES

Example 1 is a wireless device comprising: a memory configured to store a non primary channel access (NPCA) stay window; and processing circuitry that configures the wireless device to: detect overlapping basic service set (OBSS) activity on a basic service set (BSS) primary channel; transition to a NPCA primary channel in response to the OBSS activity being detected and NPCA entry conditions being fulfilled; initiate an NPCA exchange on the NPCA primary channel by transmitting an initial control frame (ICF) and receiving an initial control response (ICR) to confirm co presence on the NPCA primary channel; advertise a proposed NPCA maximum transmission opportunity (TxOP) duration, decode a peer advertised NPCA maximum TxOP duration, and reconcile a common NPCA stay window for the NPCA primary channel based on the proposed NPCA maximum TxOP duration and the peer advertised NPCA maximum TxOP duration; and return to the BSS primary channel based on early release or elapse of the common NPCA stay window.

In Example 2, the subject matter of Example 1 includes, wherein the processing circuitry is configured to: encode the proposed NPCA maximum TxOP duration in the ICF using a special user information field associated with a special association identifier (AID) value reserved for NPCA parameters and a feedback type identifying NPCA parameters, decode the peer advertised NPCA maximum TxOP duration in a multi station block acknowledgement (Multi STA BA) that includes a special per AID traffic identifier (TID) information field, and use the peer advertised NPCA maximum TxOP duration to negotiate the common NPCA stay window.

In Example 3, the subject matter of Examples 1-2 includes, wherein the processing circuitry is configured to: use a legacy duration field of the ICF to signal the proposed NPCA stay window, and set a receiver reservation on the NPCA primary channel based on the legacy duration field.

In Example 4, the subject matter of Example 3 includes, wherein the processing circuitry is configured to: determine whether the legacy duration field exceeds a permissible NPCA window or a bound tied to an inferred end of OBSS occupancy on the BSS primary channel reduced by a maximum NPCA switch back delay, and in response to a determination that the legacy duration field exceeds the permissible NPCA window or bound, refrain from acknowledging a received ICF by not transmitting an ICR in response to the received ICF to prevent initiation of an NPCA exchange with a mismatched NPCA stay window.

In Example 5, the subject matter of Examples 3-4 includes, wherein the processing circuitry is configured to: encode a contention free end (CF End) frame on the NPCA primary channel to terminate a reserved NPCA stay window early, and after transmission of the CF-End frame, transition back to the BSS primary channel for contention.

In Example 6, the subject matter of Examples 1-5 includes, wherein the processing circuitry is configured to apply access point (AP) precedence during negotiation of the common NPCA stay window by: extending a station NPCA stay to match an AP advertised NPCA maximum TxOP duration when the AP advertised NPCA maximum TxOP duration is longer than a locally computed duration, and truncating the station NPCA stay to match the AP advertised NPCA maximum TxOP duration when the AP advertised NPCA maximum TxOP duration is shorter than the locally computed duration.

In Example 7, the subject matter of Examples 1-6 includes, wherein the processing circuitry is configured to: compare a station transition delay to a maximum NPCA transition delay parameter announced for a BSS, and disable NPCA operation NPCA enablement when a transition delay of the wireless device exceeds the maximum NPCA transition delay parameter.

In Example 8, the subject matter of Examples 1-7 includes, wherein the processing circuitry is configured to implement a stricter synchronization mode in which a station that has transitioned to the NPCA primary channel waits to transmit until a frame is received from an associated AP on the NPCA primary channel to synchronize station transmission start to AP presence.

In Example 9, the subject matter of Examples 1-8 includes, wherein the processing circuitry is configured to: carry over a contention backoff counter from the BSS primary channel to the NPCA primary channel without reset, resume backoff decrementation on the NPCA primary channel upon NPCA entry, and evaluate the NPCA entry conditions to include an intra BSS reservation being zero on the BSS primary channel and an OBSS occupancy being sufficient in duration and not covering an entire bonded bandwidth used by the NPCA primary channel and NPCA secondary channels.

Example 10 is a wireless device comprising: a memory configured to store a network allocation vector (NAV); and processing circuitry that configures the wireless device to manage the NAV across a basic service set (BSS) primary channel and a non primary channel access (NPCA) primary channel during NPCA operation by: maintaining intra BSS NAV and inter BSS NAV on the BSS primary channel; maintaining an NPCA NAV on the NPCA primary channel; setting NAV values from received frame duration information including a legacy duration field; and resetting the NPCA NAV upon return from the NPCA primary channel to the BSS primary channel.

In Example 11, the subject matter of Example 10 includes, wherein the processing circuitry is configured, for physical layer protocol data unit (PPDU) based NPCA operation, to: transition to the NPCA primary channel for a duration equal to a detected overlapping basic service set (OBSS) PPDU length, maintain an inter BSS NAV on the BSS primary channel while operating on the NPCA primary channel, and upon return to the BSS primary channel, continue deferral while the inter BSS NAV counts down to zero.

In Example 12, the subject matter of Examples 10-11 includes, wherein the processing circuitry is configured to: maintain a single NPCA NAV on the NPCA primary channel without distinguishing intra BSS and inter BSS sources, and clear the NPCA NAV upon return to the BSS primary channel.

In Example 13, the subject matter of Examples 10-12 includes, wherein the processing circuitry is configured to: maintain an intra BSS NPCA NAV and an inter BSS NPCA NAV on the NPCA primary channel, treat the intra BSS NPCA NAV consistently with an intra BSS NAV on the BSS primary channel, and set the inter BSS NPCA NAV to zero at NPCA transition when NPCA operation is aligned to an OBSS transmission opportunity (TxOP).

In Example 14, the subject matter of Examples 10-13 includes, wherein the processing circuitry is configured to: use a legacy duration field of an initial control frame on the NPCA primary channel to set the NPCA NAV based on a proposed NPCA stay window, and treat non acknowledgement of the initial control frame by the wireless device when operating as a responder as a condition preventing NPCA engagement when incompatible.

In Example 15, the subject matter of Example 14 includes, wherein the processing circuitry is configured to: determine whether the proposed NPCA stay window exceeds a bound tied to an inferred end of OBSS occupancy on the BSS primary channel reduced by a maximum NPCA switch back delay, and in response to the proposed NPCA stay window exceeding the bound, refrain from acknowledging the initial control frame to maintain coherent NAV behavior across channels.

In Example 16, the subject matter of Examples 10-15 includes, wherein the processing circuitry is configured to: clear the NPCA NAV, and transition back to the BSS primary channel in response to transmission by the wireless device of a contention free end (CF End) frame on the NPCA primary channel indicating termination of a reserved period before a signaled window ends.

In Example 17, the subject matter of Examples 10-16 includes, wherein the processing circuitry is configured to: prevent NPCA entry when an intra BSS NAV on the BSS primary channel is non zero, and resume contention on the BSS primary channel when an inter BSS NAV on the BSS primary channel is zero following NPCA operation aligned to an OBSS transmission opportunity (TxOP).

In Example 18, the subject matter of Examples 10-17 includes, wherein the processing circuitry is configured to synchronize NAV timers across the BSS primary channel and the NPCA primary channel by updating or clearing NAV timers responsive to observed signaling and transitions to maintain coherent deferral periods before resuming monitoring and potential NPCA entry.

Example 19 is a non-transitory computer-readable storage medium that stores instructions for execution by a processor of a wireless device, the instructions, when executed, cause the wireless device to: manage a network allocation vector (NAV) across a basic service set (BSS) primary channel and a non primary channel access (NPCA) primary channel during NPCA operation by: maintaining intra BSS NAV and inter BSS NAV on the BSS primary channel; maintaining an NPCA NAV on the NPCA primary channel; setting NAV values from received frame duration information including a legacy duration field; and resetting the NPCA NAV upon return from the NPCA primary channel to the BSS primary channel.

In Example 20, the subject matter of Example 19 includes, wherein the instructions, when executed, cause the processor to, for physical layer protocol data unit (PPDU) based NPCA operation: transition to the NPCA primary channel for a duration equal to a detected overlapping basic service set (OBSS) PPDU length, maintain an inter BSS NAV on the BSS primary channel while operating on the NPCA primary channel, and upon return to the BSS primary channel, continue deferral while the inter BSS NAV counts down to zero.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The abstract is submitted with the understanding that it will not be used to interpret or limit the scope or meaning of the claims. In addition, in the foregoing Detailed Description, it may be seen that various features are grouped together in a single embodiment for the purpose of streamlining. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A wireless device comprising:
a memory configured to store a non-primary channel access (NPCA) stay window; and
processing circuitry that configures the wireless device to:
detect overlapping basic service set (OBSS) activity on a basic service set (BSS) primary channel;
transition to a NPCA primary channel in response to the OBSS activity being detected and NPCA entry conditions being fulfilled;
initiate an NPCA exchange on the NPCA primary channel by transmitting an initial control frame (ICF) and receiving an initial control response (ICR) to confirm co-presence on the NPCA primary channel;
advertise a proposed NPCA maximum transmission opportunity (TxOP) duration, decode a peer-advertised NPCA maximum TxOP duration, and reconcile a common NPCA stay window for the NPCA primary channel based on the proposed NPCA maximum TxOP duration and the peer-advertised NPCA maximum TxOP duration; and
return to the BSS primary channel based on early release or elapse of the common NPCA stay window.

2. The wireless device of claim 1, wherein the processing circuitry is configured to:
encode the proposed NPCA maximum TxOP duration in the ICF using a special user information field associated with a special association identifier (AID) value reserved for NPCA parameters and a feedback type identifying NPCA parameters,
decode the peer-advertised NPCA maximum TxOP duration in a multi-station block acknowledgement (Multi-STA BA) that includes a special per-AID traffic identifier (TID) information field, and
use the peer-advertised NPCA maximum TxOP duration to negotiate the common NPCA stay window.

3. The wireless device of claim 1, wherein the processing circuitry is configured to:
use a legacy duration field of the ICF to signal the proposed NPCA stay window, and
set a receiver reservation on the NPCA primary channel based on the legacy duration field.

4. The wireless device of claim 3, wherein the processing circuitry is configured to:
determine whether the legacy duration field exceeds a permissible NPCA window or a bound tied to an inferred end of OBSS occupancy on the BSS primary channel reduced by a maximum NPCA switch-back delay, and
in response to a determination that the legacy duration field exceeds the permissible NPCA window or bound, refrain from acknowledging a received ICF by not transmitting an ICR in response to the received ICF to prevent initiation of an NPCA exchange with a mismatched NPCA stay window.

5. The wireless device of claim 3, wherein the processing circuitry is configured to:
encode a contention-free end (CF-End) frame on the NPCA primary channel to terminate a reserved NPCA stay window early, and
after transmission of the CF-End frame, transition back to the BSS primary channel for contention.

6. The wireless device of claim 1, wherein the processing circuitry is configured to apply access point (AP) precedence during negotiation of the common NPCA stay window by:
extending a station NPCA stay to match an AP-advertised NPCA maximum TxOP duration when the AP-advertised NPCA maximum TxOP duration is longer than a locally computed duration, and
truncating the station NPCA stay to match the AP-advertised NPCA maximum TxOP duration when the AP-advertised NPCA maximum TxOP duration is shorter than the locally computed duration.

7. The wireless device of claim 1, wherein the processing circuitry is configured to:
compare a station transition delay to a maximum NPCA transition delay parameter announced for a BSS, and
disable NPCA operation NPCA enablement when a transition delay of the wireless device exceeds the maximum NPCA transition delay parameter.

8. The wireless device of claim 1, wherein the processing circuitry is configured to implement a stricter synchronization mode in which a station that has transitioned to the NPCA primary channel waits to transmit until a frame is received from an associated AP on the NPCA primary channel to synchronize station transmission start to AP presence.

9. The wireless device of claim 1, wherein the processing circuitry is configured to:
carry over a contention backoff counter from the BSS primary channel to the NPCA primary channel without reset,
resume backoff decrementation on the NPCA primary channel upon NPCA entry, and
evaluate the NPCA entry conditions to include an intra-BSS reservation being zero on the BSS primary channel and an OBSS occupancy being sufficient in duration and not covering an entire bonded bandwidth used by the NPCA primary channel and NPCA secondary channels.

10. A wireless device comprising:
a memory configured to store a network allocation vector (NAV); and
processing circuitry that configures the wireless device to manage the NAV across a basic service set (BSS) primary channel and a non-primary channel access (NPCA) primary channel during NPCA operation by:
maintaining intra-BSS NAV and inter-BSS NAV on the BSS primary channel;
maintaining an NPCA NAV on the NPCA primary channel;
setting NAV values from received frame duration information including a legacy duration field; and
resetting the NPCA NAV upon return from the NPCA primary channel to the BSS primary channel.

11. The wireless device of claim 10, wherein the processing circuitry is configured, for physical layer protocol data unit (PPDU)-based NPCA operation, to:
transition to the NPCA primary channel for a duration equal to a detected overlapping basic service set (OBSS) PPDU length,
maintain an inter-BSS NAV on the BSS primary channel while operating on the NPCA primary channel, and
upon return to the BSS primary channel, continue deferral while the inter-BSS NAV counts down to zero.

12. The wireless device of claim 10, wherein the processing circuitry is configured to:
maintain a single NPCA NAV on the NPCA primary channel without distinguishing intra-BSS and inter-BSS sources, and
clear the NPCA NAV upon return to the BSS primary channel.

13. The wireless device of claim 10, wherein the processing circuitry is configured to:
maintain an intra-BSS NPCA NAV and an inter-BSS NPCA NAV on the NPCA primary channel,
treat the intra-BSS NPCA NAV consistently with an intra-BSS NAV on the BSS primary channel, and
set the inter-BSS NPCA NAV to zero at NPCA transition when NPCA operation is aligned to an OBSS transmission opportunity (TxOP).

14. The wireless device of claim 10, wherein the processing circuitry is configured to:
use a legacy duration field of an initial control frame on the NPCA primary channel to set the NPCA NAV based on a proposed NPCA stay window, and
treat non-acknowledgement of the initial control frame by the wireless device when operating as a responder as a condition preventing NPCA engagement when incompatible.

15. The wireless device of claim 14, wherein the processing circuitry is configured to:
determine whether the proposed NPCA stay window exceeds a bound tied to an inferred end of OBSS occupancy on the BSS primary channel reduced by a maximum NPCA switch-back delay, and
in response to the proposed NPCA stay window exceeding the bound, refrain from acknowledging the initial control frame to maintain coherent NAV behavior across channels.

16. The wireless device of claim 10, wherein the processing circuitry is configured to:
clear the NPCA NAV, and
transition back to the BSS primary channel in response to transmission by the wireless device of a contention-free end (CF-End) frame on the NPCA primary channel indicating termination of a reserved period before a signaled window ends.

17. The wireless device of claim 10, wherein the processing circuitry is configured to:
prevent NPCA entry when an intra-BSS NAV on the BSS primary channel is non-zero, and
resume contention on the BSS primary channel when an inter-BSS NAV on the BSS primary channel is zero following NPCA operation aligned to an OBSS transmission opportunity (TxOP).

18. The wireless device of claim 10, wherein the processing circuitry is configured to synchronize NAV timers across the BSS primary channel and the NPCA primary channel by updating or clearing NAV timers responsive to observed signaling and transitions to maintain coherent deferral periods before resuming monitoring and potential NPCA entry.

19. A non-transitory computer-readable storage medium that stores instructions for execution by a processor of a wireless device, the instructions, when executed, cause the wireless device to:
manage a network allocation vector (NAV) across a basic service set (BSS) primary channel and a non-primary channel access (NPCA) primary channel during NPCA operation by:
maintaining intra-BSS NAV and inter-BSS NAV on the BSS primary channel;
maintaining an NPCA NAV on the NPCA primary channel;
setting NAV values from received frame duration information including a legacy duration field; and
resetting the NPCA NAV upon return from the NPCA primary channel to the BSS primary channel.

20. The non-transitory computer-readable storage medium of claim 19, wherein the instructions, when executed, cause the processor to, for physical layer protocol data unit (PPDU)-based NPCA operation:
transition to the NPCA primary channel for a duration equal to a detected overlapping basic service set (OBSS) PPDU length,
maintain an inter-BSS NAV on the BSS primary channel while operating on the NPCA primary channel, and
upon return to the BSS primary channel, continue deferral while the inter-BSS NAV counts down to zero.
